(19) United States
(12) Patent Application Publication
(10) Pub. No.: US 2016/0215742 A1
(43) Pub. Date: Jul. 28, 2016

(54) UNIT PUMP FOR USE IN A COMBUSTION ENGINE

(71) Applicant: GM Global Technology Operations LLC, Detroit, MI (US)

(72) Inventors: Daniele Carboni, Torino (IT); Riccardo Rossi, Castelnuovo di Garfagnana (LU) (IT); Michele Tempesta, La Loggia (To) (IT)

(73) Assignee: GM Global Technology Operations LLC, Detroit, MI (US)

(21) Appl. No.: 15/002,758

(22) Filed: Jan. 21, 2016

(30) Foreign Application Priority Data
Jan. 22, 2015 (GB) 1501065.5

(51) Int. Cl. F02M 59/10; F02M 39/00; F02M 59/48

(52) U.S. Cl. CPC F02M 59/102; F02M 59/48; F02M 39/00

(57) ABSTRACT

A unit pump for use in a combustion engine is disclosed, as well as a method for assembling said combustion engine. The unit pump includes a tappet interacting with a crankshaft or camshaft for providing the fuel injection. The tappet includes first fixing sections interacting with a fastener to position the tappet relative to the cylinder or engine housing of the combustion engine when assembled.

### CROSS-REFERENCE TO RELATED APPLICATION

This application claims priority to Great Britain Patent Application No. 1501065.5, filed Jan. 22, 2015, which is incorporated herein by reference in its entirety.

### TECHNICAL FIELD

The present disclosure pertains to a unit pump for use in a combustion engine, in particular of a Diesel engine driving a vehicle and relates to the combustion engine including the unit pump. A further aspect of the present disclosure relates to a kit of parts for mounting the unit pump on the combustion engine. Yet another aspect of the present disclosure relates to a method and a computer program for mounting the unit pump to the combustion engine.

### BACKGROUND

One of the major concerns of mankind in these days is the global warming that describes an observed century-scale rise in the average temperature of Earth's climate system. There are studies showing a dependency between rising temperature and rising emissions of carbon dioxide (CO₂). Among others CO₂ is released by combustion of fossil fuel so that a significant amount of the CO₂-emissions is caused by combustion engines used in vehicles. As a consequence, the vehicle manufacturers are intensely searching for ways for reducing CO₂-emissions. The reduction of weight of the vehicles is one promising way to reduce the CO₂-emissions. In this respect unit pumps which are a specific type of injection pumps used in gasoline and Diesel engines are considered as an important contribution for the reductions of the CO₂-emissions. Unit pumps are part of a common rail system and are additional pumps separate from the fuel pump. The unit pumps mainly serve for compressing the fuel delivered by the fuel pump before it is injected into the cylinders of a given combustion engine by respective injectors. One unit pump compresses the fuel injected to all cylinders as do high pressure fuel pumps in conventional Diesel engines. The unit pumps are driven by a camshaft or crankshaft via a tappet and may be located at any suitable position of the engine block of the combustion engine, the engine block typically forming a cylinder head.

A commonly known concept for the reduction of CO₂-emissions is the so-called downsizing in which mainly the cylinder capacity is reduced without reducing the power of the respective engine. Moreover, the number of cylinders may also be reduced so that engines having only three cylinders became available recently. As the majority of engines are based on four cylinders, the engine block needs to be redesigned which may be time-consuming and tedious. To avoid the redesign an engine block including four cylinder bores may be used, however, only three of them being equipped with a piston. The unit pump may be inserted into the remaining bore and fastened on the cylinder head. Particularly in the latter case the unit pumps do not need any casing so that their weight can be reduced. Moreover, unit pumps are lubricated by the engine oil and not by the fuel itself as in conventional Diesel engines. Thus, there is no need to lubricate the fuel so that the load on the fuel pump at low pressure can be reduced. Both facts lead to a reduction of CO₂-emissions.

Moreover, a very compact and space-saving design can be achieved by integrating the unit pump into the cylinder or engine housing and by using the crankshaft or the camshaft of the combustion engine for actuating the unit pump.

Usually, the tappet is releasably connectable with the unit pump and movable relative to the unit pump against the pretension force of a pretension device. Depending on the configuration the pretention device is pretentioned either by the camshaft or the crankshaft. Upon assembly of the combustion engine the tappet has to be placed into a position in which the pretention device is pretentioned before the camshaft or the crankshaft is turned into a position to take over the pretentioning of the pretention device. To do so it is necessary that the crankshaft or the camshaft is already mounted on the combustion engine. To hold the tappet in the described position known assembly lines include particularly designed pushing devices. Next to the particular and thus expensive design the pushing devices are difficult to operate, in particular due to the fact that the access to the cylinders is obstructed by the crankshaft and/or the camshaft.

### SUMMARY

In accordance with one aspect of the present disclosure a unit pump and a combustion engine is provided that facilitate the mounting of the unit pump on the combustion engine. It is a further aspect of the present disclosure to provide a method for assembling a respective combustion engine. Preferred embodiments of the present disclosure are subject of the following description and claims, as well as the attached figures.

The respective combustion engine includes a cylinder formed by a cylinder or engine housing, a crankshaft for transmitting the power provided by the combustion engine to power consuming units of the vehicle, and a camshaft for controlling the flow of air/fuel mixture intake and exhaust gases into and out of the cylinder. The unit pump is fixable to the cylinder or engine housing for compressing the fuel delivered by a fuel pump. The unit pump according to one embodiment includes a tappet interacting with the crankshaft or the camshaft for actuating the unit pump. The tappet is provided with first fixing sections interacting with a pin or rod-shaped fastener to position the tappet relative to the cylinder or engine housing upon mounting the unit pump to the combustion engine or upon assembly of the combustion engine. The first fixing sections are designed for an interaction with fastener so that the tappet can be positioned in a desired position relative to the cylinder or engine housing for a certain period of time before the crankshaft or the camshaft are ready to interact with the tappet. It depends on the chosen configuration of the combustion engine whether the camshaft or the crankshaft is interacting with the tappet. The unit pump enables the mounting of the unit pump on the cylinder or engine housing before the combustion engine is provided with the crankshaft or the camshaft. As the crankshaft or the camshaft in this assembling state does not obstruct the access to the cylinder or engine housing the mounting of the unit pump is significantly facilitated. Moreover, the use of the expensive pushing devices is not necessary anymore no that the costs for the assembly line can be reduced. Beyond that the unit pump can be mounted to the cylinder or engine housing in a preassembly station so the logistics and the assembly processes are more flexible and thus more efficient.

In another embodiment the first fixing sections include recesses and/or protrusions for providing a form closure with the fastener. Recesses and protrusions are easy to provide so that the additional costs for implementing the inventive concept are manageable. Moreover, recesses and protrusions can be provided in a way so that they are very reliable and long-lasting. Providing a form closure for holding the tappet in the assembly position by means of protrusions and recesses is an easy task so that the error rate during the assembly process is very low.

In a further embodiment the fastener is releasably engagable with the first fixing sections. The fastener can be removed after the crankshaft or the camshaft take over the pretensioning of the pretension device and be used in the assembly of another combustion engine. The fastener is reusable and thus sustainable.

In an embodiment of a combustion engine, in particular of a Diesel engine driving a vehicle, the combustion engine including a cylinder formed by a cylinder or engine housing. The cylinder or engine housing includes second fixing sections interacting with fastener to position the tappet of a unit pump according to one of the embodiments previously presented relative to the cylinder or engine housing upon mounting of the unit pump on the combustion engine. The advantages and technical effects obtained by this embodiment of the combustion engine are the same as described for the inventive unit pump. In particular the assembly of the combustion engine is facilitated as it is possible to connect the unit shaft to the cylinder or engine housing before the camshaft and the crankshaft are mounted so that the latter do not obstruct the access to the cylinder or engine housing.

In another embodiment the second fixing sections include recesses and/or protrusions for providing a form closure with the fastener. Recesses and protrusions are easy to provide so that the additional costs for implementing the inventive concept are manageable. Moreover, recesses and protrusions can be provided in a way so that they are very reliable and long-lasting. Providing a form closure for holding the tappet in the assembly position by means of protrusions and recesses is an easy task so that the error rate during the assembly process is very low.

In yet another embodiment the fastener is releasably engagable with the second fixing sections. The fastener can be removed after the crankshaft or the camshaft take over the pretensioning of the pretension device and be used in the assembly of another combustion engine. The fastener is reusable and thus sustainable.

The present disclosure also provides a kit of parts for mounting a unit pump on a combustion engine, including a unit pump according to one of the embodiments previously presented, a combustion engine according to one of the embodiments previously presented, and a fastener interacting with the first fixing sections of the unit pump and with the second fixing sections of the combustion engine for positioning the tappet relative to the cylinder or engine housing upon mounting of the unit pump on the combustion engine.

The advantages and technical effects obtained by this kit of parts for mounting the unit pump on the combustion engine are the same as described for the inventive unit pump and the combustion engine as such. In particular the assembly of the combustion engine is facilitated as it is possible to connect the unit shaft to the cylinder or engine housing before the camshaft and the crankshaft are mounted so that the latter do not obstruct the access to the cylinder or engine housing.

The present disclosure also provides an embodiment of a method for assembling a combustion engine. A tappet separated from the unit pump is placed in an assembly position relative to the cylinder or engine housing. The tappet is fixed in the assembly position by positioning the fastener so that they interact with the fixing sections. The unit pump or the tappet is provided with a pretension device so that the unit pump is connected with the tappet by connecting the unit pump to the cylinder or engine housing, thereby pretensioning the pretension device. The advantages and technical effects obtained by this method for assembling the combustion engine are the same as described for the inventive unit pump and the combustion engine as such.

In a further development of the present method the combustion engine further includes a crankshaft for transmitting the power provided by the combustion engine to power consuming units of the vehicle, and a camshaft a camshaft for controlling the flow of air/fuel mixture intake and exhaust gases into and out of the cylinder. The crankshaft or the camshaft is mounted on the combustion engine and turned into a position in which it is interacting with the tappet to fix the tappet in the assembly position. The fastener is removed from the fixing sections. In this embodiment the assembly of the combustion engine is facilitated as it is possible to connect the unit shaft to the cylinder or engine housing before the camshaft and the crankshaft are mounted so that the latter do not obstruct the access to the cylinder or engine housing.

In another embodiment the tappet is provided separate from the unit pump, and in the first instance placing the tappet in an assembly position relative to the cylinder or engine housing, fixing the tappet in the assembly position by positioning the fastener so that they interact with the fixing sections, providing the unit pump or the tappet with a pretension device, and connecting the unit pump with the tappet by connecting the unit pump to the cylinder or engine housing, thereby pretensioning the pretension device. Next, the crankshaft or the camshaft is mounted on the combustion engine, wherein turning the crankshaft or the camshaft into a position in which it is interacting with the tappet to fix the tappet in the assembly position, and removing the fastener from the fixing sections are conducted in a second place different from the first place. It is thus possible to carry out the assembling process of the combustion engine in at least two different places. Hereby logistical advantages may be realized as a supplier may already mount the unit pumps on the cylinder or engine housing whereas the crankshaft and the camshaft are mounted on the combustion engine by the car manufacturer.

An embodiment further includes a computer program for mounting a unit pump according to one of the embodiments previously presented on a combustion engine according to one of the embodiments previously presented, the computer program including instructions that, when executed provides the tappet separated from the unit pump, places the tappet in an assembly position relative to the cylinder or engine housing, fixes the tappet in the assembly position by positioning the fastener so that they interact with the fixing sections, provides the unit pump or the tappet with a pretension device, and connects the unit pump with the tappet by connecting the unit pump to the cylinder or engine housing, thereby pretensioning the pretension device.

The advantages and technical effects obtained by this method for assembling the combustion engine are the same as described for the inventive unit pump, the combustion engine as such and the method for assembling the combustion engine.

In the context of a combustion engine having a crankshaft for transmitting the power provided by the combustion engine to power consuming units of the vehicle, and a camshaft for controlling the flow of air/fuel mixture intake and exhaust gases into and out of the cylinder, the computer program mounts the crankshaft or the camshaft on the combustion engine, turns the crankshaft or the camshaft into a position in which it is interacting with the tappet to fix the tappet in the assembly position, and removes the fastener from the fixing sections.

In this embodiment the assembly of the combustion engine is facilitated as it is possible to connect the unit shaft to the cylinder or engine housing before the camshaft and the crankshaft are mounted so that the latter do not obstruct the access to the cylinder or engine housing.

### BRIEF DESCRIPTION OF THE DRAWINGS

The present disclosure will hereinafter be described in conjunction with the following drawing figures, wherein like numerals denote like elements.

FIG. 1 is a schematic view of one embodiment of a unit pump;

FIGS. 2 to 8 are a cross-section through a cylinder of a combustion engine in which different stages of the assembly process are shown by a schematic diagram; and

FIG. 9 is a flowchart schematically illustrating a method for assembling a combustion engine having the unit pump shown in FIGS. 1-8.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

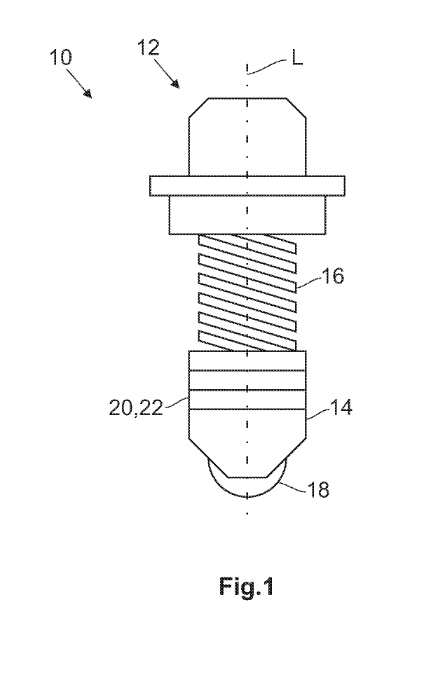

In FIG. 1 one embodiment of a unit pump 10 is shown. The unit pump 10 includes a pump head 12 interacting with a tappet 14. A pretension device 16, e.g., a spring, is providing a pretension force between the tappet 14 and the pump head 12 acting along a longitudinal axis L. In operation the tappet 14 is movable along the longitudinal axis L against and with the pretension force whereas the pump head 12 is stationary. The tappet 14 includes a roller 18 rotatably mounted on the tappet 14. Further the tappet 14 is provided with first fixing sections 20 that are embodied as first recesses 22.

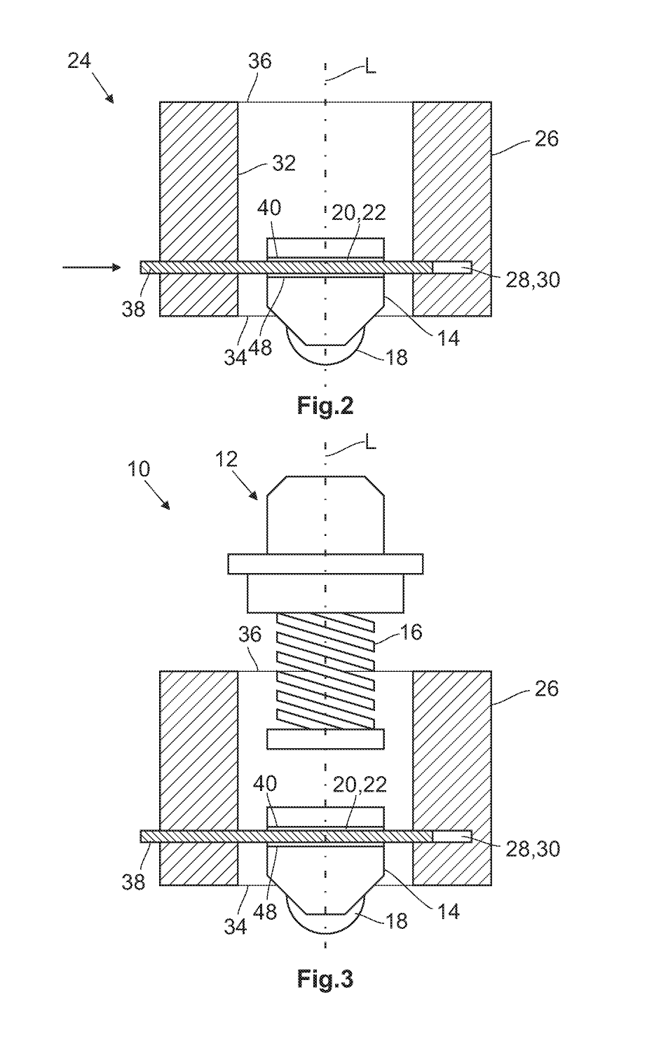

FIGS. 2 to 8 are a cross-section through a cylinder 24 of a combustion engine (not shown). The figures schematically show different stages of an assembly process. In FIG. 2 the first step of the assembly process is demonstrated. The cylinder 24 of the combustion engine is formed by a cylinder or engine housing 26. The cylinder or engine housing 26 is provided with second fixing sections 28 that are embodied as second recesses 30. Moreover the cylinder or engine housing 26 has a central bore 32 with a first end 34 and a second end 36. The central bore 32 can be a cylinder bore of a combustion engine that is not equipped with pistons, valves etc. to perform the combustion process due to downsizing reasons. Existing cylinder bores can be used to arrange the unit pump in a way that its tappet may be driven by the crank shaft that is typically arranged opposite the cylinder head, i.e., at the first end 34.

As initially explained the downsizing also includes the reduction of the number of cylinders. A combustion engine including e.g. four cylinders and four cylinder bores may be used but only three of them equipped with pistons, valves etc. to perform the combustion process. The remaining fourth cylinder and the respective central bore 32, i.e., the cylinder bore, may be used for arranging the unit pump 10. As the majority of combustion engines used for vehicles include four cylinders the reduction to three cylinders does not require the construction of a new engine block. Moreover, the cylinder bore not used for performing the combustion process is used for the arrangement of the unit pump 10 such that no additional holes or other fastening sections are needed. This concept is not limited to a particular number of cylinders.

The tappet 14 is separated from the unit pump 10 and fixed in an assembly position relative to the cylinder or engine housing 26 by pin or fastener 38 having a rod-shaped section fastener. The fastener 38 may a bolt. To fix the tappet 14 in the assembly position the fastener 38 is introduced into the first and second fixing sections 20, 28. In the assembly position at least the roller 18 of the tappet 14 is protruding the first end 34. Moreover, the tappet 14 may have two first fixing sections 20 and the cylinder or engine housing 26 may have two second fixing sections 28 so that the fastener 38 may be U-shaped to simultaneously introduce the fastener 38 into the two first and the second fixing sections 20, 28.

In the next step of the assembly process as shown in FIG. 3, the pump head 12 and the pretension device 16 are introduced into the central bore 32 of the cylinder or engine housing 26 via the second end 36. Subsequently the pump head 12 is fastened to the cylinder or engine housing 26 by fasteners that are not further shown (FIG. 4). As the tappet 14 is fixed in the assembly position the pretension device 16 is compressed so that the fasteners have to he tightened against the pretension force exerted by the pretension device 16 as indicated by the arrows A. As evident from FIG. 3 the first recess is slightly oversized with respect to the fastener 38. As a consequence the tappet 14 is slightly pushed towards the first end 34 when the pump head 12 is fastened to the cylinder or engine housing 26. The fastener 38 is now butting against an upper surface 40 of the first recess 22.

The steps previously described may be conducted in a first location, whereas the subsequent steps may be conducted in a second location to which the combustion engine may be transported meanwhile.

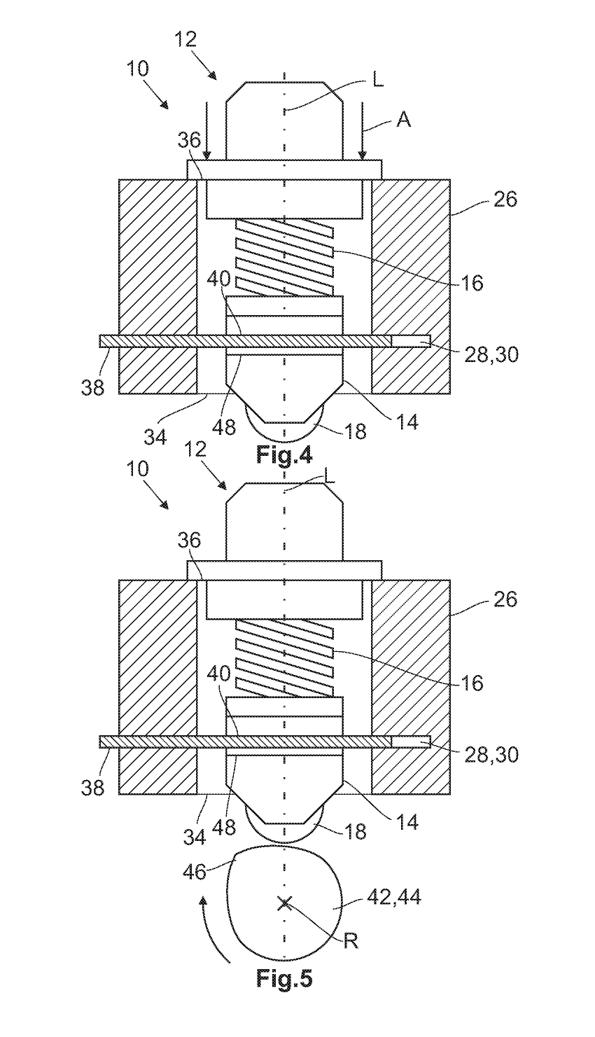

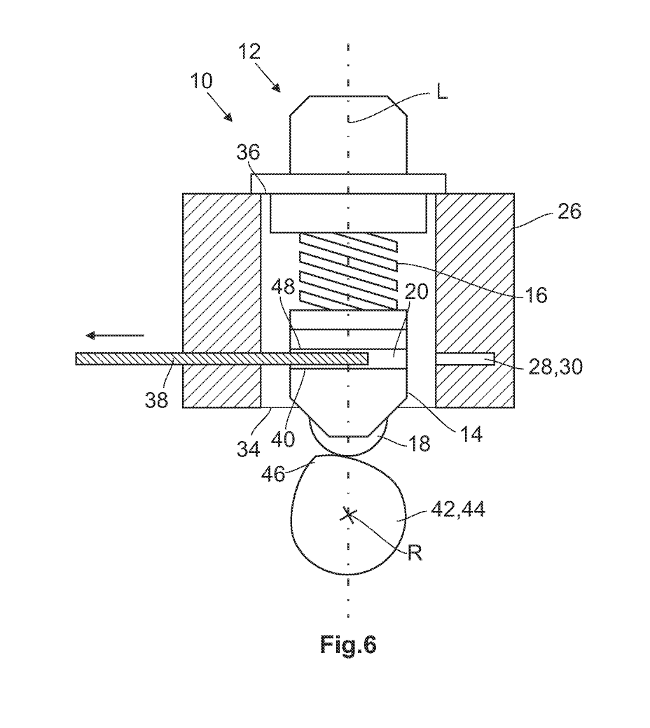

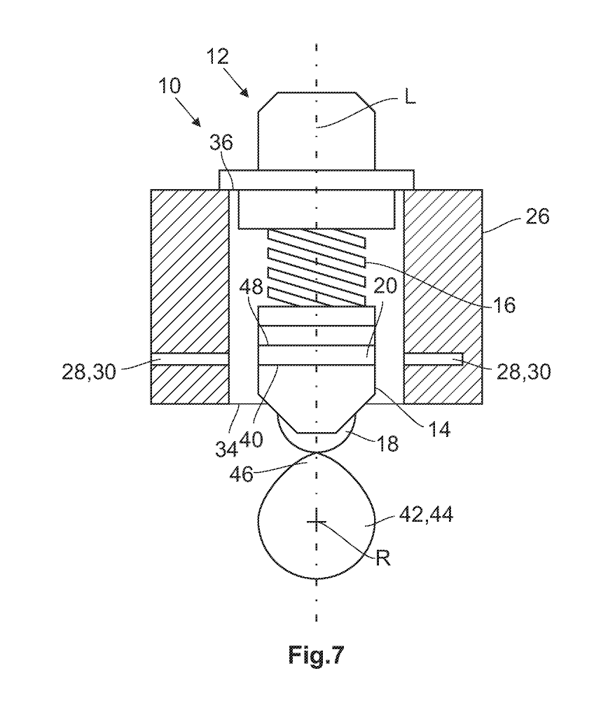

In FIG. 5 the next step of the assembly process is shown in which a crankshaft 42 or a camshaft 44 is mounted on the combustion engine. The crankshaft 42 or a camshaft 44 is rotatable around a rotational axis R. The rotational axis R is running perpendicularly through the longitudinal axis L. It depends on the design of the combustion engine whether the crankshaft 42 or the camshaft 44 is interacting with the unit pump 10, however, the following steps can be conducted regardless of the chosen design. Both the camshaft 44 and the crankshaft 42 have eccentric portions 46. The camshaft 44 and the crankshaft 42 are mounted so that the eccentric portions 46 initially do not contact the tappet 14. After that the crankshaft 42 or the camshaft 44 is turned so that the eccentric portion 46 is contacting the roller 18 of the tappet 14 (FIG. 6). In the shown example the crankshaft 42 or the camshaft 44 is turned clockwise around the rotational axis R. Turning the crankshaft 42 or the camshaft 44 further moves the tappet 14 towards the pump head 12 thereby counteracting the pretension force exerted by the pretension device 16. Thus, the fastener 38 is not butting against the upper surface 40 of the first recess anymore and can now easily be removed. The position of the tappet 14 relative to the cylinder or engine housing 26 is now completely governed by the rotational position of the crankshaft 42 or the camshaft 44. The unit pump 10 and the crankshaft 42 or the camshaft 44 are now completely mounted and ready to operate (FIG. 7)

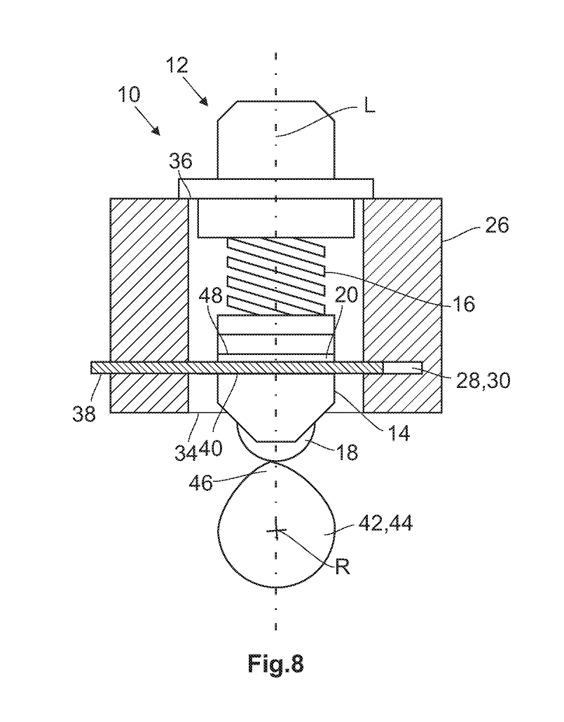

In FIG. 8, the camshaft 44 or the crankshaft 42 is in a rotational position in which a line (not shown) between the rotational axis R and the top of the eccentric portion 46 is almost running through the longitudinal axis L. In this rotational position the tappet 14 is almost pushed towards the second end 36 at maximum. However, the fastening means is not removed. Now the fastening means butt against a lower surface 40 of the first recess so no axial movement of the tappet 14 is possible anymore. Consequently the further rotation of the crankshaft 42 or the camshaft 44 is prevented. The blocked camshaft 44 or crankshaft 42 can be used as an indicator that the fastening means was erroneously not removed to ensure proper assembly. The camshaft 44 or the crankshaft 42 has to be turned in the opposite direction, namely counterclockwise to remove the fastening means (see FIG. 6).

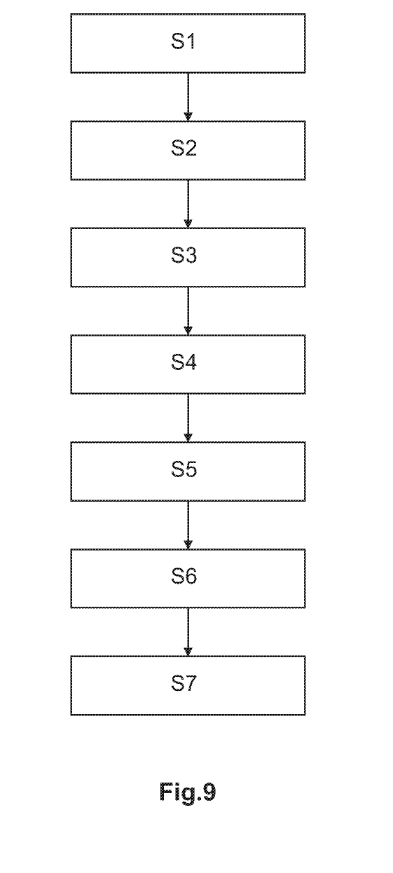

In FIG. 9, a flow chart of the method executed by the computer program is given. At Block S1 the tappet (14) is provided separated from the unit pump (10). At Block S2 the tappet (14) is placed in an assembly position relative to the cylinder or engine housing (26) and the tappet (14) is fixed in the assembly position by positioning the fastener (38) so that they interact with the fixing sections (20, 28) At Block S3, the unit pump (10) or the tappet (14) is provided with a pretension device (16). At Block S4, the unit pump (10) is connected with the tappet (14) by connecting the unit pump (10) to the cylinder or engine housing (26), thereby pretensioning the pretension device (16). At Block S5 the crankshaft (42) or the camshaft (44) is mounted on the combustion engine. At Block S6, the crankshaft (42) or the camshaft (44) is rotated into a position in which it is interacting with the tappet (14) to fix the tappet (14) in the assembly position. At Block S7 the fastener (38) is removed from the fixing sections. The method is described above in the preferred sequence; however, FIG. 8 is not to be understood in a way that the respective embodiments of the method and the computer program are limited to this sequence.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A unit pump fixable to in a cylinder formed in a cylinder housing of combustion engine for compressing the fuel delivered by a fuel pump, the unit pump comprising a tappet interacting with one of the crankshaft or the camshaft for actuating the unit pump, wherein the tappet includes a first fixing section interacting with a fastener to position the tappet relative to the cylinder housing upon mounting of the unit pump on the combustion engine.

14. The unit pump according to claim 13, wherein the first fixing sections comprise recesses for providing a form closure with the fastener.

15. The unit pump according to claim 13, wherein the first fixing sections comprise protrusions for providing a form closure with the fastener.

16. The unit pump according to claim 13, wherein the fastener is releasably engagable with the first fixing sections.

17. A combustion engine configured to power a vehicle, the combustion engine comprising a cylinder formed by a cylinder housing having second fixing sections interacting with the fastener to position the tappet of a unit pump according to claim 13 relative to the cylinder housing upon mounting of the unit pump on the combustion engine.

18. The combustion engine according to claim 17, wherein the second fixing sections comprise recesses for providing a form closure with the fastener.

19. The combustion engine according to claim 17, wherein the second fixing sections comprise protrusions for providing a form closure with the fastener.

20. The combustion engine according to claim 17, wherein the fastener is releasably engagable with the second fixing sections.

21. A kit of parts for mounting a unit pump according to claim 13 on a combustion engine having a cylinder formed by a cylinder housing having second fixing sections, and a fastener interacting with the first fixing sections of the unit pump and with the second fixing sections of the combustion engine for positioning the tappet relative to the cylinder housing upon mounting of the unit pump on the combustion engine.

22. A method for mounting a unit pump on a combustion engine having a cylinder housing, the method comprising:
providing a tappet separated from a unit pump;
placing the tappet in an assembly position relative to the cylinder housing;
fixing the tappet in the assembly position by positioning a fastener to interact with a first fixing section;
providing a pretension device with at least one of the tappet or the unit pump; and
connecting the unit pump with the tappet by connecting the unit pump to the cylinder housing, thereby pretensioning the pretension device.

23. The method according to claim 22, wherein the combustion engine includes a crankshaft and a camshaft, the method further comprising:
mounting at least one of the crankshaft and the camshaft on the combustion engine;
rotating at least one of the crankshaft and the camshaft into a position to interact with the tappet for fixing the tappet in the assembly position; and
removing the fastener from the first fixing section.

24. The method according to claim 22, wherein the tappet is provided separated from the unit pump and the method further comprises:
placing the tappet in an assembly position relative to the cylinder housing;
fixing the tappet in the assembly position by positioning the fastener to interact with the first fixing sections;
providing at least one of the unit pump or the tappet with a pretension device; and
connecting the unit pump with the tappet by connecting the unit pump to the cylinder housing, thereby pretensioning the pretension device as follows:
mounting at least one of the crankshaft or the camshaft on the combustion engine;
rotating the at least one crankshaft or the camshaft into a position in which it is interacting with the tappet to fix the tappet in the assembly position; and
removing the fastener from the first fixing section.
